(19) United States
(12) Patent Application Publication
(10) Pub. No.: US 2025/0183304 A1
(43) Pub. Date: Jun. 5, 2025

(54) CARBON MATERIAL, METHOD FOR PRODUCING CARBON MATERIAL, NEGATIVE ELECTRODE, AND SECONDARY BATTERY

(71) Applicant: Mitsubishi Chemical Corporation, Tokyo (JP)

(72) Inventors: Hisako KONDO, Tokyo (JP); Nobuyuki ISHIWATARI, Tokyo (JP); Hiroaki YOSHIDA, Tokyo (JP); Masakazu YOKOMIZO, Tokyo (JP)

(73) Assignee: Mitsubishi Chemical Corporation, Tokyo (JP)

(21) Appl. No.: 19/043,578

(22) Filed: Feb. 3, 2025

Related U.S. Application Data
(63) Continuation of application No. PCT/JP2023/022438, filed on Jun. 16, 2023.

(30) Foreign Application Priority Data
Aug. 3, 2022 (JP) 2022-124174

(51) Int. Cl. H01M 4/587; C01B 32/00; H01M 4/02; H01M 10/0525

(52) U.S. Cl. CPC H01M 4/587; C01B 32/00; H01M 10/0525; C01P 2006/12; C01P 2006/40; H01M 2004/021; H01M 2004/027

(57) ABSTRACT

A carbon material may achieve excellent discharge load characteristic of a secondary battery and excellent high-temperature storage recovery rate of the secondary battery, and to provide a method for producing a carbon material that achieves excellent discharge load characteristic of a secondary battery and excellent high-temperature storage recovery rate of the secondary battery. A carbon material may satisfy formulas (1) and (2) below, or a carbon material may contain a carbon material (A) satisfying formula (3), below, and a carbon material (B) satisfying formula (4):

$$0.1 \leq SAe / SAp \leq 1.2 ; \qquad ( 1 )$$

$$1 \leq α \leq 10 ; \qquad ( 2 )$$

$$0.1 \leq α1 \leq 6 ; and \qquad ( 3 )$$

$$8 \leq α2 \leq 20. \qquad ( 4 )$$

### TECHNICAL FIELD

The present invention relates to a carbon material, a method for producing a carbon material, a negative electrode, and a secondary battery.

### BACKGROUND ART

In recent years, with an advance in miniaturization of electronic devices, demands for high-capacity secondary batteries have increased significantly. In particular, secondary batteries, particularly lithium ion secondary batteries, have a high energy density and superior charge-discharge characteristics as compared with nickel-cadmium batteries or nickel-hydrogen batteries, and these batteries have gained attention. The lithium ion secondary batteries that have been developed and put to practical use include a non-aqueous lithium secondary battery including a positive electrode and a negative electrode capable of storing and releasing lithium ions, and a non-aqueous electrolytic solution in which a lithium salt such as LiPF₆ or LiBF₄ is dissolved.

In the related art, extensive studies have been conducted for improving the performance of lithium ion secondary batteries. In recent years, demands for a further improvement in the performance of lithium ion secondary batteries have increased. For example, Patent Literature 1 discloses a negative electrode material having a pore volume in a specific range for improvement in the performance of a non-aqueous secondary battery.

### CITATION LIST

### Patent Literature

Patent Literature 1: WO 2020/196914

### SUMMARY OF INVENTION

### Technical Problem

However, when the negative electrode material disclosed in Patent Literature 1 is subjected to pressing to increase its density, the specific surface area of an electrode plate increases due to damage to a binder or active material particles, leading to a poor high-temperature storage recovery rate of a secondary battery.

The present invention has been made in view of such a problem, and an object of the present invention is to provide a carbon material that achieves excellent discharge load characteristic of a secondary battery and excellent high-temperature storage recovery rate of a secondary battery. Another object of the present invention is to provide a method for producing a carbon material that achieves excellent discharge load characteristic of a secondary battery and excellent high-temperature storage recovery rate of a secondary battery.

### Solution to Problem

Although various types of negative electrode materials have been studied so far, no candidate has been found for a negative electrode material, with which both the discharge load characteristic of a secondary battery and the high-temperature storage recovery rate of a secondary battery can be achieved in a balanced manner. As a result of extensive studies for solving the above-described problems, the present inventors have found that both the discharge load characteristic of a secondary battery and the high-temperature storage recovery rate of a secondary battery can be achieved in a balanced manner by using a carbon material that satisfies two formulae described below, and thus have completed the present invention.

A first aspect of the present invention is

a carbon material satisfying Formulae (1) and (2) below:

$$0.1 \leq SAe / SAp \leq 1.2 \qquad ( 1 )$$

$$1 \leq α \leq 10 \qquad ( 2 )$$

(in Formula (1), SAp represents a specific surface area of the carbon material in powder form, and SAe represents a specific surface area of the carbon material at an inflection point in a load-density curve when it is pressed into an electrode plate; and in Formula (2), α represents a rate of change in tortuosity factor in a press density range of 1.3 g/cm³ to 1.7 g/cm³ of the carbon material).

A second aspect of the present invention is

the carbon material according to the first aspect, wherein SAp is 1.5 m²/g to 4.5 m²/g.

A third aspect of the present invention is

the carbon material according to the first or second aspect, wherein SAe is 0.5 m²/g to 3.5 m²/g.

A fourth aspect of the present invention is

the carbon material according to any one of the first to third aspects, wherein the carbon material has a volume-based average particle size of 5 μm to 25 μm.

A fifth aspect of the present invention is

a carbon material containing a carbon material (A) satisfying Formula (3) below and a carbon material (B) satisfying Formula (4) below:

$$0.1 \leq α1 \leq 6 \qquad ( 3 )$$

$$8 \leq α2 \leq 20 \qquad ( 4 )$$

(in Formula (3), α1 represents a rate of change in tortuosity factor in a press density range of 1.3 g/cm³ to 1.7 g/cm³ of the carbon material; and in Formula (4), α2 represents a rate of change in tortuosity factor in a press density range of 1.3 g/cm³ to 1.7 g/cm³ of the carbon material).

A sixth aspect of the present invention is

the carbon material according to the fifth aspect, wherein a ratio Rd50 of a volume-based average particle size of the carbon material (B) to a volume-based average particle size of the carbon material (A) is 0.3 to 1.6.

A seventh aspect of the present invention is

the carbon material according to the fifth or sixth aspect, wherein a ratio RSAp of a specific surface area of the carbon material (B) to a specific surface area of the carbon material (A) is 2 to 15.

An eighth aspect of the present invention is

the carbon material according to any one of the fifth to seventh aspects, wherein a ratio RTap of a tap density of the carbon material (B) to a tap density of the carbon material (A) is 0.7 to 1.4.

A ninth aspect of the present invention is

the carbon material according to any one of the fifth to eighth aspects, wherein a content of the carbon material (A) is 50 mass % to 95 mass %, and a content of the carbon material (B) is 5 mass % to 50 mass %.

A tenth aspect of the present invention is

a method for producing the carbon material described in any one of the fifth to ninth aspects, the method including mixing the carbon material (A) and the carbon material (B).

An eleventh aspect of the present invention is

a negative electrode including a current collector, and an active material layer formed on the current collector, wherein

the active material layer contains the carbon material described in any one of the first to ninth aspects.

A twelfth aspect of the present invention is

a secondary battery including a positive electrode, a negative electrode, and an electrolyte, wherein

the negative electrode is the negative electrode described in the eleventh aspect.

### Advantageous Effects of Invention

When the carbon material of the present invention is used as an active material of a negative electrode of a secondary battery, it is possible to achieve both the discharge load characteristic of the secondary battery and the high-temperature storage recovery rate of the secondary battery in a balanced manner. In addition, the carbon material can be produced by the method for producing a carbon material according to the present invention.

### Description of Embodiments

Hereinafter, the present invention will be described in detail, but the present invention is not limited to the following embodiments and can be carried out with various modifications within the scope of the gist thereof. In the present specification, a numerical range expressed by using the term “to” means that the numerical values or physical property values before and after “to” are included in the numerical range.

### Carbon Material

In one embodiment, the carbon material of the present invention satisfies the following Formula (1) and the following Formula (2).

$$0.1 \leq SAe / SAp \leq 1.2 \qquad ( 1 )$$

$$1 \leq α \leq 10 \qquad ( 2 )$$

In Formula (1), SAp represents a specific surface area of the carbon material in powder form, and SAe represents a specific surface area at an inflection point in a load-density curve when the carbon material is pressed into an electrode plate. In Formula (2), α represents a rate of change in tortuosity factor in a press density range of 1.3 g/cm³ to 1.7 g/cm³ of the carbon material.

In the present specification, the carbon material refers to a material containing elemental carbon in an amount of 90 mass % or more.

When Formula (1) and Formula (2) described above are satisfied, the carbon material of the present invention ensures a void structure suitable for migration of lithium ions and suppresses an excessive increase in the specific surface area of the electrode plate when the carbon material is pressed into an electrode plate, thereby making it possible to achieve both the discharge load characteristic of a secondary battery and the high-temperature storage recovery rate of the secondary battery in a balanced manner.

The carbon material of the present invention preferably satisfies the following Formula (1′), more preferably satisfies the following Formula (1″), and even more preferably satisfies the following Formula (1′″), from the viewpoints of suppressing a side reaction with an electrolytic solution, and achieving excellent high-temperature storage characteristics.

$$0.1 \leq SAe / SAp \leq 1. \qquad ( {1}^{′} )$$

$$0.4 \leq SAe / SAp \leq 0.95 \qquad ( {1}^{″} )$$

$$0.6 \leq SAe / SAp \leq 0.9 \qquad ( {1}^{′′′} )$$

The powder specific surface area SAp of the carbon material of the present invention is preferably 1.5 m²/g or more, and more preferably 2.0 m²/g or more from the viewpoint of achieving excellent lithium ion acceptability. The powder specific surface area SAp is preferably 4.5 m²/g or less, and more preferably 4.0 m²/g or less from the viewpoint of achieving excellent initial charge-discharge efficiency.

In the present specification, the powder specific surface area SAp is a value measured by a BET method.

Specifically, the measurement is performed as follows: in a specific surface area measuring apparatus, a sample is subjected to preliminary drying at 350° C. under reduced pressure for 15 minutes under a nitrogen gas flow; then the sample is cooled to a liquid nitrogen temperature; and the powder specific surface area of the sample is measured according to a nitrogen adsorption single-point BET method based on a gas flow method, using a nitrogen-helium mixed gas, whose relative pressure of nitrogen to the atmospheric pressure is accurately adjusted to 0.3.

The electrode plate specific surface area SAe of the carbon material of the present invention is preferably 0.5 m²/g or more, and more preferably 1.0 m²/g or more from the viewpoint of achieving excellent rapid charge-discharge characteristics and low-temperature input-output characteristics. The electrode plate specific surface area SAe is preferably 3.5 m²/g or less, and more preferably 3.0 m²/g or less from the viewpoint of achieving excellent initial charge-discharge efficiency and initial gas suppression.

In the present specification, the electrode plate specific surface area SAe is a value measured by the BET method.

Specifically, the measurement is performed as follows: in a specific surface area measuring apparatus, a sample is subjected to preliminarily drying at 100° C. under reduced pressure for 30 minutes under a nitrogen gas flow; then the sample is cooled to the liquid nitrogen temperature; and the electrode plate specific surface area is measured according to the nitrogen adsorption single-point BET method based on the gas flow method, using a nitrogen-helium mixed gas, whose relative pressure of nitrogen is accurately adjusted to 0.3.

The carbon material of the present invention preferably satisfies the following Formula (2′) and more preferably satisfies the following Formula (2″), from the viewpoints of maintaining a suitable void structure when the carbon material is pressed into an electrode plate and achieving excellent discharge load characteristics.

$$2 \leq α \leq 10 \qquad ( {2}^{′} )$$

$$3 \leq α \leq 10 \qquad ( {2}^{″} )$$

In the present specification, a rate of change in tortuosity factor in a press density range of 1.3 g/cm³ to 1.7 g/cm³ is calculated from impedance response analysis.

In the impedance response analysis, an impedance analyzer is used to perform measurement under conditions of a frequency of 20 kHz to 10 mHz and a voltage amplitude of 10 mV. An intersection of a 45° straight line in a high frequency region and a vertical line in a low frequency region on a Cole-Cole plot is used to determine an ionic resistance Rᵢₒₙ for an active material layer of a negative electrode sheet. The tortuosity factor is calculated from the following Formula (5) wherein S represents the area of the negative electrode sheet, L represents the thickness of the active material layer of the negative electrode sheet, σ represents the electrical conductivity of the electrolytic solution, and ϵ represents the porosity of the active material layer.

$$Tortuosity factor = {R}_{ion} \times ( ε / 2 \times L ) \times ( σ \times S ) \qquad ( 5 )$$

The calculated tortuosity factor is used to calculate the rate of change in tortuosity factor in a press density range of 1.3 g/cm³ to 1.7 g/cm³ from the following Formula (6).

$$[ Rate of change in tortuosity factor ] = [ amount of change in tortuosity factor ] / [ amount of change in press density ] \qquad ( 6 )$$

The volume-based average particle size d50 of the carbon material of the present invention is preferably 5 μm or more, more preferably 8 μm or more, and even more preferably 10 μm or more, from the viewpoints of suppressing an excessive reaction with an electrolytic solution and achieving excellent initial charge-discharge efficiency. The volume-based average particle size d50 is preferably 25 μm or less, more preferably 22 μm or less, and even more preferably 20 μm or less from the viewpoint of suppressing streaking during formation of an electrode plate.

In the present specification, the volume-based average particle size d50 is a value of a volume-based median size measured by a laser diffraction/scattering particle size distribution analyzer.

Specifically, 0.01 g of a sample is suspended in 10 mL of a 0.2 mass % aqueous solution of polyoxyethylene sorbitan monolaurate as a surfactant, the suspension is introduced into a laser diffraction/scattering particle size distribution analyzer and irradiated with ultrasonic waves of 28 kHz at an output power of 60 W for 1 minute, and then a volume-based median size in the analyzer is measured.

The tap density of the carbon material of the present invention is preferably 0.70 g/cm³ or more, more preferably 0.80 g/cm³ or more, and even more preferably 0.90 g/cm³ or more from the viewpoints of: suppressing process defects such as streaking at the time of formation of an electrode plate; facilitating the formation of a negative electrode sheet having good rollability and a high density due to increased fillability; reducing a tortuosity factor of migration path of lithium ions when the carbon material is formed into an electrode plate; and achieving smooth transfer of the electrolytic solution due to aligned forms of voids between particles and improving rapid charge-discharge characteristics. The tap density is preferably 1.40 g/cm³ or less, more preferably 1.30 g/cm³ or less, and even more preferably 1.10 g/cm³ or less, from the viewpoints of: allowing the particles to have appropriate spaces on their surfaces or in their interiors and preventing the particles to become too hard, and thus achieving excellent electrode plate pressability; and achieving excellent rapid charge-discharge characteristics and low-temperature input-output characteristics.

In the present specification, the tap density is a density calculated from the volume and mass of a sample when the sample is dropped into a cylindrical tap cell having a diameter of 1.6 cm and a volumetric capacity of 20 cm³ to fill the cell to a full capacity and then tapping is performed 1000 times with a stroke length of 10 mm, by using a powder density measuring device.

The circularity of the carbon material of the present invention is preferably 0.88 or more, more preferably 0.90 or more, and even more preferably 0.92 or more, from the viewpoint of: reducing the tortuosity factor of lithium ion diffusion; allowing smooth migration of the electrolytic solution into voids between particles; and achieving the excellent rapid charge-discharge characteristics. The circularity is preferably 0.99 or less, more preferably 0.98 or less, and even more preferably 0.97 or less, from the viewpoints of ensuring the contact between carbon material particles and achieving excellent cycle characteristics.

In the present specification, the circularity is calculated from the following Formula (9) by measuring a particle size distribution of an equivalent circle diameter by flow particle image analysis.

Specifically, ion-exchanged water is used as a dispersion medium, polyoxyethylene sorbitan monolaurate is used as a surfactant, and ultrasonic dispersion is performed to obtain a dispersion liquid. Thereafter, the images of particle shapes are captured using a flow image analyzer. From captured images of at least 1000 or more particles, the particles having an equivalent circle diameter in a range of 1.5 μm to 40 μm are selected and the values of circularity are averaged for these particles. This average value is defined as the circularity. [Circularity]=[perimeter of equivalent circle having same area as projected shape of particle]/[actual perimeter of projected shape of particle] (9)

The cumulative pore volume of the carbon material of the present invention is preferably 0.003 mL/g or more, more preferably 0.005 mL/g or more, and even more preferably 0.010 mL/g or more, and is preferably 0.120 mL/g or less, more preferably 0.090 mL/g or less, and even more preferably 0.070 mL/g or less, from the viewpoint of facilitating deformation of the carbon material to an appropriate degree at the time of pressing.

In the present specification, the cumulative pore volume in a pore size range of 0.01 μm or more and 1 μm or less is a value measured using a mercury porosimeter by a mercury porosimetry.

Specifically, the carbon material is weighed to have a value of about 0.2 g using a mercury porosimeter, sealed in a cell for powder, and pretreated by degassing at 25° C. and 50 μmHg or less for 10 minutes. Subsequently, the cell is depressurized to 4 psia, mercury is introduced into the cell, and the cell is pressurized in a stepwise manner from 4 psia to 40000 psia, and then depressurized to 25 psia. The number of steps at the time of pressurization is 80 or more, and in each step, the amount of mercury intruded is measured after an equilibrium time of 10 seconds. From the resultant mercury intrusion curve, a pore distribution is calculated using a Washburn equation. The pore distribution is calculated using a surface tension (γ) and a contact angle (Ψ) of mercury as 485 dyne/cm and 140°, respectively. From the resultant pore distribution, a cumulative pore volume in a pore size range of 0.01 μm or more and 1 μm or less is calculated.

The d10 of the carbon material of the present invention is preferably 1 μm or more, more preferably 3 μm or more, and even more preferably 5 μm or more, from the viewpoints of suppressing aggregation tendency of the particles, and achieving excellent slurry stability and electrode plate strength. The d10 is preferably 30 μm or less, more preferably 20 μm or less, and even more preferably 17 μm or less, from the viewpoint of suppressing streaking during formation of an electrode plate.

In the present specification, d10 is defined as a value at which the integrated frequency reaches 10%, when the frequency % of particles is integrated from the smallest particle size in the particle distribution obtained in the measurement of the volume-based average particle size d50.

The d90 of the carbon material of the present invention is preferably 20 μm or more, more preferably 25 μm or more, and even more preferably 30 μm or more, from the viewpoint that a decrease in electrode plate strength can be suppressed. The d90 is preferably 100 μm or less, more preferably 70 μm or less, and even more preferably 50 μm or less, from the viewpoint of suppressing streaking during formation of an electrode plate.

In the present specification, d90 is defined as a value at which the integrated frequency reaches 90% when the frequency % of particles is integrated from the smallest particle size in the particle size distribution obtained in the measurement of the volume-based average particle size d50.

The dibutyl phthalate (DBP) oil absorption of the carbon material of the present invention is preferably 20 mL/100 g or more, more preferably 30 mL/100 g or more, and even more preferably 40 mL/100 g or more, from the viewpoint that, due to the presence of suitable voids between particles, a reduction in reaction surface area can be prevented. The DBP oil absorption is preferably 85 mL/100 g or less, more preferably 70 mL/100 g or less, and even more preferably 65 mL/100 g or less, from the viewpoint of suppressing streaking during formation of an electrode plate.

In the present specification, the DBP oil absorption is a value measured in accordance with ISO 4546.

Specifically, the DBP oil absorption is a value obtained by charging 40 g of a sample and performing measurement at a dropping rate of 4 mL/min, the number of revolutions of 125 rpm, and a set torque of 500 N·m. Examples of the measuring apparatus include Absorptometer E type available from Brabender Technologies.

In another embodiment, the carbon material of the present invention contains a carbon material (A) satisfying the following Formula (3) and a carbon material (B) satisfying the following Formula (4).

$$0.1 \leq α1 \leq 6 \qquad ( 3 )$$

$$8 \leq α2 \leq 20 \qquad ( 4 )$$

In Formula (3), α1 represents a rate of change in tortuosity factor in a press density range of 1.3 g/cm³ to 1.7 g/cm³ of the carbon material. In Formula (4), α2 represents a rate of change in tortuosity factor in a press density range of 1.3 g/cm³ to 1.7 g/cm³ of the carbon material.

When the carbon material of the present invention contains the carbon material (A) satisfying Formula (3) and the carbon material (B) satisfying Formula (4), the carbon material of the present invention is likely to satisfy Formula (1) and Formula (2).

### Carbon Material (A)

The carbon material (A) satisfies the following Formula (3).

$$0.1 \leq α1 \leq 6 \qquad ( 3 )$$

When the carbon material of the present invention contains the carbon material (A), the carbon material plays a role of maintaining a void structure when pressed into an electrode plate, and achieves excellent diffusibility of lithium ions.

The carbon material (A) preferably satisfies the following Formula (3′), and more preferably satisfies the following Formula (3″), from the viewpoint of suppressing an excessive load when the carbon material is pressed into an electrode plate.

$$0.5 \leq α1 \leq 5.5 \qquad ( {3}^{′} )$$

$$1 \leq α1 \leq 5 \qquad ( {3}^{″} )$$

The powder specific surface area SAp of the carbon material (A) is preferably 0.3 m²/g or more, more preferably 0.5 m²/g or more, and even more preferably 0.8 m²/g or more, from the viewpoint of ensuring the presence of a site through which lithium enters and exits and achieving excellent rapid charge-discharge characteristics. The powder specific surface area SAp is preferably 8.0 m²/g or less, more preferably 5.0 m²/g or less, and even more preferably 2.5 m²/g or less, from the viewpoints of suppressing side reaction with an electrolytic solution and achieving excellent initial charge-discharge efficiency.

The tap density of the carbon material (A) is preferably 0.60 g/cm³ or more, more preferably 0.80 g/cm³ or more, and even more preferably 1.00 g/cm³ or more, from the viewpoint of achieving excellent fillability during formation of an electrode plate. The tap density is preferably 1.40 g/cm³ or less, more preferably 1.35 g/cm³ or less, and even more preferably 1.30 g/cm³ or less, from the viewpoint of achieving excellent electrical conductivity between particles.

The volume-based average particle size d50 of the carbon material (A) is preferably 1 μm or more, more preferably 5 μm or more, and even more preferably 10 μm or more, from the viewpoint of suppressing an excessive reaction with an electrolytic solution and achieving excellent initial charge-discharge efficiency. The volume-based average particle size d50 is preferably 40 μm or less, more preferably 30 μm or less, and even more preferably 20 μm or less, from the viewpoint of suppressing streaking during formation of an electrode plate.

The circularity of the carbon material (A) is preferably 0.88 or more, more preferably 0.90 or more, and even more preferably 0.92 or more, from the viewpoint of ensuring the presence of a lithium ion migration path in the electrolytic solution when an electrode plate is formed, and achieving excellent high-current density charge-discharge characteristics. The circularity is preferably 0.99 or less, more preferably 0.98 or less, and even more preferably 0.97 or less, from the viewpoint of ensuring a sufficient contact area between particles, and achieving an excellent electrical conductivity.

The d002 value of the carbon material (A) is preferably 3.40 Å or less, and more preferably 3.38 Å or less, because graphite is highly crystalline and has a sufficient charge-discharge capacity. The theoretical d002 value of graphite is 3.354 Å, and natural graphite having high crystallinity has a d002 value close to the theoretical value. The d002 value of artificial graphite varies greatly depending on the type of raw coke and the graphitization temperature.

The Lc of the carbon material (A) is preferably 950 Å or more, and more preferably 1000 Å or more because graphite is highly crystalline and has a sufficient charge-discharge capacity.

In the present specification, the d002 value is a value of an interplanar spacing of a lattice plane (002 plane) measured by X-ray diffractometry in accordance with a method of the Japan Society for the Promotion of Science, and Lc is a value of a size of a crystallite measured by X-ray diffractometry in accordance with the method of the Japan Society for the Promotion of Science. The measurement conditions of X-ray diffractometry are as follows.

Sample: a sample prepared by mixing a measurement target with X-ray standard high purity silicon powder in an amount of about 15 mass % relative to the total amount

### X-ray: CuKα ray

Measurement range: 20°≤2θ≤30°
Step angle: 0.013°
Sample preparation: a sample plate recess having a depth of 0.2 mm is filled with a powder sample to prepare a flat sample surface

The Raman R value of the carbon material (A) is preferably 0.10 or more, more preferably 0.15 or more, and even more preferably 0.20 or more, from the viewpoints that the crystals are less likely to be oriented in the plane direction when the density is increased and deterioration of charge-discharge load characteristics can be prevented. The Raman R value is preferably 0.80 or less, more preferably 0.70 or less, and even more preferably 0.60 or less, from the viewpoints that an excessive reaction with an electrolytic solution can be suppressed and a decrease in charge-discharge efficiency and an increase in gas generation can be prevented.

In the present specification, the Raman R value is a value obtained by measuring the intensity I_{A} of the peak P_{A} around 1580 cm⁻¹ and the intensity I_{B} of the peak P_{B} around 1360 cm⁻¹ in a Raman spectrum determined by Raman spectrometry and calculating the intensity ratio (I_{B}/I_{A}).

In the present specification, “around 1580 cm⁻¹” refers to a range of 1580 cm⁻¹ to 1620 cm⁻¹, and “around 1360 cm⁻¹” refers to a range of 1350 cm⁻¹ to 1370 cm⁻¹.

The Raman spectrum is measured using a Raman spectrometer. Specifically, by allowing the carbon material to fall freely into the measurement cell, the measurement cell is filled with the carbon material, and measurement is performed while the inside of the measurement cell is irradiated with argon ion laser light and the measurement cell is rotated in a plane perpendicular to the laser light. The measurement conditions are as follows.

Wavelength of argon ion laser light: 514.5 nm
Laser power on sample: 25 mW
Resolution: 4 cm⁻¹
Measurement range: 1100 cm⁻¹ to 1730 cm⁻¹
Peak intensity measurement, peak half-width measurement: background processing, smoothing processing (5-point convolution by simple averaging)

The carbon material (A) is preferably graphite having a coating on at least a part of the surface thereof, more preferably graphite having a carbonaceous substance on at least a part of the surface thereof, and even more preferably graphite having an amorphous carbonaceous substance on at least a part of the surface thereof, from the viewpoint of achieving excellent lithium ion acceptability.

In 100 mass % of the carbon material (A), the content of the amorphous carbonaceous substance in the carbon material (A) is preferably 0.1 mass % or more, more preferably 1 mass % or more, and even more preferably 3 mass % or more, from the viewpoint of achieving better uniformity of coating and excellent charge acceptability. The content of the amorphous carbonaceous substance is preferably 30 mass % or less, more preferably 20 mass % or less, and even more preferably 15 mass % or less, from the viewpoint of achieving excellent rollability during formation of an electrode plate.

In the present specification, the content of the amorphous carbonaceous substance in the carbon material is calculated by the following Formula (10). That is, it is calculated from the masses of the carbon material and the amorphous carbonaceous substance before and after firing. In this case, calculation is performed on the assumption that there is no change in mass of the carbon material before and after firing.

$$Content of amorphous carbonaceous substance ( mass \% ) = [ ( mass of amorphous carbonaceous substance - containing carbon material after firing - mass of carbon material before firing ) / mass of carbon material before firing ] \times 100 \qquad ( 10 )$$

### Method for Producing Carbon Material (A)

The method for producing the carbon material (A) is not particularly limited as long as the carbon material (A) can be produced to satisfy Formula (3) described above. However, the production method is preferably a method in which a raw material of the carbon material is subjected to a spheroidization treatment in the presence of a granulating agent, followed by a pressurization treatment, and the resultant product is impregnated with an amorphous carbon precursor, from the viewpoint of achieving high capacity and excellent input-output characteristics and cycle characteristics. Specifically, a production method including the following steps (1) to (6) is preferred.

Step (1): a step of adjusting the particle size of a raw material of the carbon material
Step (2): a step of mixing the raw material of the carbon material with a granulating agent
Step (3): a step of spheroidizing the raw material of the carbon material
Step (4): a step of removing the granulating agent
Step (5): a step of performing a pressurization treatment
Step (6): a step of impregnating the carbon material with an amorphous carbonaceous substance

Hereinafter, the steps (1) to (6) will be described, but steps other than the steps (1) to (6) may be included, and the production method is not limited to the method including the steps (1) to (6).

### Step (1)

Step (1) is a step of adjusting the particle size of the raw material of the carbon material.

The raw material of the carbon material is preferably graphite, more preferably natural graphite or artificial graphite because of high crystallinity and good capacity, and even more preferably natural graphite because of higher crystallinity, better capacity, and no need for a heat treatment during production. The graphite preferably contains a small amount of impurities, and the graphite is more preferably subjected to a purification treatment as necessary.

Examples of the natural graphite include amorphous graphite, scale-like graphite, and scaly graphite. Among these natural graphites, scale-like graphite or scaly graphite is preferred, and scaly graphite is more preferred, because of a high degree of graphitization and a small amount of impurities.

Examples of the artificial graphite include those obtained by graphitizing an organic substance such as coal tar pitch, coal-based heavy oil, reduced crude, petroleum-based heavy oil, aromatic hydrocarbon, nitrogen-containing cyclic compound, sulfur-containing cyclic compound, polyphenylene, polyvinyl chloride, polyvinyl alcohol, polyacrylonitrile, polyvinyl butyral, natural polymer, polyphenylene sulfide, polyphenylene oxide, furfuryl alcohol resin, phenol-formaldehyde resin, or imide resin by heating at 2500° C. or higher.

The d002 value of the raw material of the carbon material is preferably 3.360 Å or less, and more preferably 3.357 Å or less, because graphite is highly crystalline and has a sufficient charge-discharge capacity.

The Lc of the raw material of the carbon material is preferably 900 Å or more and more preferably 1000 Å or more because graphite is highly crystalline and has a sufficient charge-discharge capacity.

The purity of the raw material of the carbon material is preferably 99.0% or more, more preferably 99.5% or more, even more preferably 99.9% or more, and particularly preferably 100%, from the viewpoints of excellent capacity and battery safety.

In the present specification, the purity is a value calculated from the masses of the raw material of the carbon material before and after heating, as obtained by accurately weighing about 10 g of the raw material of the carbon material that has been sufficiently dried and heating the weighed material at 815° C. for 10 hours in the atmosphere.

The volume-based average particle size (d50) of the raw material of the carbon material is preferably 1 μm or more, more preferably 3 μm or more, and even more preferably 5 μm or more, from the viewpoint of excellent transportability. The volume-based average particle size (d50) is preferably 150 μm or less, more preferably 130 μm or less, and even more preferably 120 μm or less from the viewpoint of excellent productivity.

The specific surface area (SA) of the raw material of the carbon material is preferably 1.0 m²/g or more, more preferably 1.5 m²/g or more, and even more preferably 2.0 m²/g or more from the viewpoint that the shape can be controlled. The specific surface area (SA) is preferably 30.0 m²/g or less, more preferably 20.0 m²/g or less, and even more preferably 10.0 m²/g or less from the viewpoint of controlling an irreversible capacity efficiently.

The tap density of the raw material of the carbon material is preferably 0.60 g/cm³ or more, more preferably 0.70 g/cm³ or more, and even more preferably 0.80 g/cm³ or more, from the viewpoint of excellent transportability. The tap density is preferably 1.40 g/cm³ or less, more preferably 1.30 g/cm³ or less, and even more preferably 1.20 g/cm³ or less, from the viewpoint of controlling the raw material easily during pulverization.

The Raman R value of the raw material of the carbon material is preferably 0.10 or more, more preferably 0.15 or more, and even more preferably 0.20 or more, from the viewpoints that crystals are less likely to be oriented in the plane direction when the density is increased and a decrease in charge-discharge load characteristics can be prevented. The Raman R value is preferably 0.80 or less, more preferably 0.70 or less, and even more preferably 0.60 or less, from the viewpoints that an excessive reaction with an electrolytic solution can be suppressed; and a decrease in charge-discharge efficiency and an increase in gas generation can be prevented.

The method for adjusting the particle size of the raw material of the carbon material is not particularly limited as long as the particle size can be adjusted to have a volume-based average particle size and a specific surface area to be described below, and pulverization, disintegration, and classification only need be performed.

Known methods can be used for pulverization, disintegration, and classification.

The volume-based average particle size (d50) of the raw material of the carbon material after particle size adjustment is preferably 1 μm or more, more preferably 2 μm or more, and even more preferably 3 μm or more, and is preferably 20 μm or less, more preferably 15 μm or less, and even more preferably 12 μm or less, from the viewpoint of controlling the spheroidization treatment easily.

The specific surface area (SA) of the raw material of the carbon material after particle size adjustment is preferably 5.0 m²/g or more, more preferably 7.5 m²/g or more, and even more preferably 10.0 m²/g or more, from the viewpoints of ensuring the presence of a portion through which lithium ions enter and exit and achieving excellent rapid charge-discharge characteristics and low-temperature input-output characteristics. The specific surface area (SA) is preferably 30.0 m²/g or less, more preferably 25.0 m²/g or less, and even more preferably 20.0 m²/g or less, from the viewpoints of: suppressing a side reaction with an electrolytic solution; preventing a reduction in initial charge-discharge efficiency and an increase in gas generation amount; and improving a battery capacity.

The tap density of the raw material of the carbon material after particle size adjustment is preferably 0.60 g/cm³ or more, more preferably 0.70 g/cm³ or more, and even more preferably 0.80 g/cm³ or more, and is preferably 1.40 g/cm³ or less, more preferably 1.30 g/cm³ or less, and even more preferably 1.20 g/cm³ or less, from the viewpoint of achieving an excellent spheroidization degree during the spheroidization treatment.

### Step (2)

Step (2) is a step of mixing the raw material of the carbon material with a granulating agent.

The granulating agent is preferably in liquid form when the raw material of the carbon material is subjected to the spheroidization treatment.

The granulating agent preferably contains an organic compound that becomes amorphous carbon.

In addition, the granulating agent is preferably an agent containing no organic solvent, an agent containing organic solvents in which at least one of the organic solvents does not have a flash point, or an agent containing an organic solvent and having a flash point of 5° C. or higher.

In the case where the granulating agent satisfies the above requirements, when the raw material of the carbon material is subjected to the spheroidization treatment, the granulating agent forms liquid bridges between molecules of the raw material of the carbon material, and an attractive force is generated between molecules of the raw material of the carbon material by a capillary negative pressure of the liquid bridges and a surface tension of the liquid. As a result, the distance between molecules of the raw material of the carbon material can be effectively shortened.

Examples of the method for mixing the raw material of the carbon material with the granulating agent include a method in which the raw material of the carbon material and the granulating agent are mixed using a mixer or a kneader, and a method in which the raw material of the carbon material is added to a solution in which the granulating agent is dissolved and then the solvent is removed. Among these methods, a method in which the raw material of the carbon material and the granulating agent are mixed using a mixer or a kneader is preferred, from the viewpoint that micropores of 1 nm to 4 nm can be efficiently reduced.

The amount of the granulating agent added is preferably 0.1 parts by mass or more, more preferably 1 part by mass or more, and even more preferably 10 parts by mass or more, and is preferably 1000 parts by mass or less, more preferably 100 parts by mass or less, and even more preferably 50 parts by mass or less, relative to 100 parts by mass of the raw material of the carbon material, from the viewpoints that a decrease in spheroidization degree due to a decrease in attractive force between molecules of the raw material of the carbon material can be suppressed, and a decrease in productivity due to the adhesion of the raw material of the carbon material to an apparatus can be suppressed.

### Step (3)

Step (3) is a step of subjecting the raw material of the carbon material to spheroidization treatment.

When the raw material of the carbon material is subjected to the spheroidization treatment, excellent rapid charge-discharge characteristics are achieved.

The method for spheroidizing the raw material of the carbon material is preferably a method in which a mechanical energy is applied to spheroidize the raw material of the carbon material, from the viewpoint that the shape of particles can be easily controlled.

Examples of the mechanical energy include impact, compression, friction, and shear force. One type of these mechanical energies may be used alone or two or more thereof may be used in combination.

In the method in which a mechanical energy is applied for spheroidization treatment of the raw material of the carbon material, an apparatus for applying a mechanical energy only need be used.

The viscosity of the granulating agent during the spheroidization treatment of the raw material of the carbon material is preferably 1 cP or higher, more preferably 5 cP or higher, even more preferably 10 cP or higher, and particularly preferably 20 cP or higher, and is preferably 1000 cP or lower, more preferably 800 cP or lower, even more preferably 600 cP or lower, and particularly preferably 500 cP or lower, from the viewpoints that: re-detachment from spheroidized particles due to an impact force with a rotor or a casing during the spheroidization treatment can be suppressed; micropores can be reduced by the granulating agent entering the micropores of 1 nm to 4 nm to form amorphous carbon; and excellent low-temperature input-output characteristics and high-temperature storage characteristics are achieved.

The viscosity of the granulating agent when the raw material of the carbon material is subjected to the spheroidization treatment can be adjusted by controlling the amount of the organic solvent and the temperature of the spheroidization treatment.

In the present specification, the viscosity is a value measured at 25° C. using a rheometer. In a case where the shearing stress at a shearing speed of 100 s⁻¹ is 0.1 Pa or more, the value measured at a shearing speed of 100 s⁻¹ is used. In a case where the shearing stress at a shearing speed 100 s⁻¹ is less than 0.1 Pa, the value measured at a shearing speed 1000 s⁻¹ is used. In a case where the shearing stress at a shearing speed 1000 s⁻¹ is less than 0.1 Pa, the value measured at the shearing speed at which the shearing stress is 0.1 Pa or more is used.

When the raw material of the carbon material is subjected to the spheroidization treatment, the raw material of the carbon material may be granulated in the presence of an additional substance. Examples of the additional substance include metals that can be alloyed with lithium, oxides thereof, amorphous carbon, and raw coke.

When the raw material of the carbon material is subjected to the spheroidization treatment, it is preferable to perform the spheroidization treatment while fine powder generated during the spheroidization treatment is attached to the surface of the carbon material. When the carbon material is coated with an amorphous carbonaceous substance or a graphitic substance, voids in the carbon material can be effectively reduced by performing the spheroidization treatment while fine powder generated during the spheroidization treatment is attached to the surface of the carbon material. In addition, the amount of edges that can be used as sites for insertion and desorption of lithium ions is increased, the electrolytic solution is efficiently distributed to voids in the carbon material, and excellent low-temperature input-output characteristics and cycle characteristics are achieved.

The fine powder may be fine powder generated during the spheroidization treatment. Alternatively, fine powder having an adjusted particle size may be added separately.

To effectively attach the fine powder to the surface of the carbon material, it is preferable to increase the attractive force between carbon material particles, between carbon material particles and fine powder particles, or between fine powder particles.

Examples of the attractive force between particles include a van der Waals force or an electrostatic attractive force without intervention of an interparticle inclusion, and a physical crosslinking force or chemical crosslinking force with intervention of an interparticle inclusion.

The van der Waals force comes to satisfy a condition: [own weight]<[attractive force], with the volume-based average particle size (d50) of 100 μm as a turnaround point, and the smaller the volume-based average particle size, the larger the attractive force. Accordingly, a decrease in the volume-based average particle size of the raw material of the carbon material leads to an increase in the attractive force between particles, and the fine powder is likely to adhere to the carbon material and to be included in the spheroidized carbon material, which is preferred.

Step (2) and step (3) may be performed at the same time by charging the raw material of the carbon material and the granulating agent into a spheroidization treatment apparatus.

### Step (4)

Step (4) is a step of removing the granulating agent.

The granulating agent may be removed completely or partially.

In a case where a granulating agent containing an organic solvent is used, it is preferable to remove the organic solvent as well.

Examples of the method for removing the granulating agent or the method for removing the organic solvent include a method of washing with a solvent and a method of heating to volatilize or decompose the granulating agent or the organic solvent. Among these methods, the method of heating to volatilize or decompose the granulating agent or the organic solvent is preferred from the viewpoints of excellent productivity and removal efficiency.

### Step (5)

The step (5) is a step of performing a pressurization treatment.

Examples of the pressurization treatment include an isotropic pressurization treatment and an anisotropic pressurization treatment. Among these pressurization treatments, the isotropic pressurization treatment is preferred from the viewpoint that it can be controlled to satisfy Formula (3).

Examples of the pressurizing means include a hydrostatic isotropic pressurization treatment using water as a pressurizing medium, an isotropic pressurization treatment by pneumatic pressure using a gas such as air as a pressurizing medium, and a pressurization treatment in which a mold is filled and pressurized in a certain direction by a uniaxial press.

The pressure for pressurization is preferably 50 MPa or more, more preferably 100 MPa or more, and even more preferably 150 MPa or more, and is preferably 300 MPa or less, more preferably 280 MPa or less, and even more preferably 260 MPa or less, from the viewpoint that it is easily controlled to satisfy Formula (3).

Step (5) may be performed at any timing in step (1) to step (6), but is preferably performed between step (4) and step (6), from the viewpoint that the pressurization can be efficiently performed in a state where the excess granulating agent is removed.

### Step (6)

Step (6) is a step of impregnating the carbon material with an amorphous carbonaceous substance.

When the carbon material is impregnated with the amorphous carbonaceous substance, a side reaction between the negative electrode and the electrolytic solution can be suppressed, and high capacity and excellent low-temperature input-output characteristics and high-temperature storage characteristics are achieved.

The amorphous carbonaceous substance refers to carbon having a d002 value of 0.340 nm or more.

The method for impregnating the carbon material with the amorphous carbonaceous substance is preferably a method in which the carbon material and an amorphous carbonaceous substance precursor are mixed and heated in a non-oxidizing atmosphere for amorphous carbonization of the amorphous carbonaceous substance precursor, from the viewpoints of suppressing an excessive side reaction with the electrolytic solution and achieving excellent initial charge-discharge efficiency.

Examples of the method for mixing the carbon material and the amorphous carbonaceous substance precursor include a method in which the carbon material and the amorphous carbonaceous substance precursor are mixed using a mixer or a kneader, and a method in which the carbon material is added to a solution in which the amorphous carbonaceous substance precursor is dissolved and then the solvent is removed. Among these methods, the method in which the carbon material and the amorphous carbonaceous substance precursor are mixed using a mixer or a kneader is preferred from the viewpoint that micropores of 1 nm to 4 nm can be efficiently reduced.

The atmosphere during heating is not particularly limited as long as it is a non-oxidizing atmosphere. However, the atmosphere is preferably a nitrogen, argon, or carbon dioxide atmosphere, and more preferably a nitrogen atmosphere, from the viewpoint that generation of micropores due to oxidation can be suppressed.

The oxygen concentration is preferably 1 vol % or less and more preferably 0.1 vol % or less from the viewpoint that it is easily controlled to satisfy Formula (3).

The heating temperature in a case of amorphous carbonization of the amorphous carbonaceous substance precursor is not particularly limited as long as it is not a temperature at which a crystal structure equivalent to the crystal structure of graphite is achieved. However, the heating temperature is preferably 500° C. or higher, more preferably 600° C. or higher, and even more preferably 700° C. or higher, and is preferably 2000° C. or lower, more preferably 1800° C. or lower, and even more preferably 1600° C. or lower.

The heating time is preferably 0.1 hours or longer and more preferably 1 hour or longer, and is preferably 1000 hours or shorter and more preferably 100 hours or shorter, from the viewpoint that it is easily controlled to satisfy Formula (3).

Examples of the amorphous carbonaceous substance precursor include tar, pitch, aromatic hydrocarbons such as naphthalene and anthracene, and thermoplastic resins such as phenolic resins and polyvinyl alcohol resins. One of these precursors may be used alone, or two or more thereof may be used in combination. Among these precursors, tar, pitch, and aromatic hydrocarbons are preferred, from the viewpoints that a carbon structure is easily developed and coating can be performed with a small amount, and those having a residual carbon rate of 50% or more are more preferred and those having a residual carbon rate of 60% or more are even more preferred, from the viewpoint that it is easily controlled to satisfy Formula (3).

The ash content in the amorphous carbonaceous substance precursor is preferably 0.00001 mass % or more, and preferably 1 mass % or less, more preferably 0.5 mass % or less, and even more preferably 0.1 mass % or less in 100 mass % of the amorphous carbonaceous substance precursor, from the viewpoint that it is easily controlled to satisfy Formula (3).

The metal impurity content in the amorphous carbonaceous substance precursor is preferably 0.1 mass ppm or more, and is preferably 1000 mass ppm or less, more preferably 500 mass ppm or less, and even more preferably 100 mass ppm or less from the viewpoint that it is easily controlled to satisfy the Formula (3).

In the present specification, the metal impurity content is a value obtained by dividing the total content of Fe, Al, Si, and Ca in the amorphous carbonaceous substance precursor by the residual carbon content.

The Qi (quinoline insoluble content) in the amorphous carbonaceous substance precursor is preferably 5 mass % or less and more preferably 3 mass % or less in 100 mass % of the amorphous carbonaceous substance precursor from the viewpoint that it is easily controlled to satisfy Formula (3).

The carbon material produced through steps (1) to (6) may be pulverized, disintegrated, and classified as necessary to adjust the volume-based average particle size of the carbon material (A) to fall within a desired range.

Known methods can be used for pulverization, disintegration, and classification.

In 100 mass % of the mixture of the carbon material and the amorphous carbonaceous substance precursor, the content of the amorphous carbonaceous substance precursor in the mixture of the carbon material and the amorphous carbonaceous substance precursor is preferably 0.1 mass % or more, more preferably 1 mass % or more, and even more preferably 3 mass % or more, from the viewpoints of achieving a more uniform coating state and achieving excellent charge acceptability. The content of the amorphous carbonaceous substance precursor is preferably 30 mass % or less, more preferably 20 mass % or less, and even more preferably 15 mass % or less, from the viewpoint of excellent rollability during formation of an electrode plate.

### Carbon Material (B)

The carbon material (B) satisfies the following Formula (4).

$$8 \leq α2 \leq 20 \qquad ( 4 )$$

When the carbon material of the present invention contains the carbon material (B), rollability at the time of pressing of an electrode plate is improved, a load applied to particles in the electrode plate is dispersed, and an increase in the specific surface area of the electrode plate is suppressed, thereby achieving excellent high-temperature storage characteristics.

The carbon material (B) preferably satisfies the following Formula (4′), and more preferably satisfies the following Formula (4″), from the viewpoints of suppressing excessive deformation of particles and achieving excellent diffusibility of lithium ions.

$$9 \leq α2 \leq 19 \qquad ( {4}^{′} )$$

$$10 \leq α2 \leq 18 \qquad ( {4}^{″} )$$

The powder specific surface area SAp of the carbon material (B) is preferably 3.0 m²/g or more, more preferably 4.0 m²/g or more, and even more preferably 5.0 m²/g or more, from the viewpoint of achieving excellent acceptability of lithium ions. The powder specific surface area SAp is preferably 20.0 m²/g or less, more preferably 15.0 m²/g or less, and even more preferably 10.0 m²/g or less, from the viewpoints of suppressing a side reaction with an electrolytic solution and achieving excellent initial charge-discharge efficiency.

The tap density of the carbon material (B) is preferably 0.70 g/cm³ or more, more preferably 0.75 g/cm³ or more, and even more preferably 0.80 g/cm³ or more, from the viewpoint of achieving excellent fillability during formation of an electrode plate. The tap density is preferably 1.30 g/cm³ or less, more preferably 1.20 g/cm³ or less, and even more preferably 1.10 g/cm³ or less, from the viewpoint of achieving excellent electrical conductivity between particles.

The volume-based average particle size d50 of the carbon material (B) is preferably 1 μm or more, more preferably 5 μm or more, and even more preferably 10 μm or more, from the viewpoints of suppressing an excessive reaction with an electrolytic solution and achieving excellent initial charge-discharge efficiency. The volume-based average particle size d50 is preferably 40 μm or less, more preferably 30 μm or less, and even more preferably 20 μm or less, from the viewpoint of suppressing streaking during formation of an electrode plate.

The circularity of the carbon material (B) is preferably 0.88 or more, more preferably 0.90 or more, and even more preferably 0.92 or more, from the viewpoints of: ensuring a migration path of lithium ions in an electrolytic solution, when an electrode plate is formed; and achieving excellent high-current density charge-discharge characteristics. The circularity is preferably 0.99 or less, more preferably 0.98 or less, and even more preferably 0.97 or less, from the viewpoints of ensuring a sufficient contact area between particles, and achieving an excellent electrical conductivity.

The d002 value of the carbon material (B) is preferably 3.40 Å or less, and more preferably 3.38 Å or less because graphite is highly crystalline and has a sufficient charge-discharge capacity. The theoretical d002 value of graphite is 3.354 Å, and natural graphite having high crystallinity has a d002 value close to the theoretical value. Meanwhile, the d002 value of artificial graphite varies greatly depending on the type of raw coke and the graphitization temperature.

The Lc of the carbon material (B) is preferably 950 Å or more, and more preferably 1000 Å or more because graphite is highly crystalline and has a sufficient charge-discharge capacity.

The Raman R value of the carbon material (B) is preferably 0.10 or more, more preferably 0.15 or more, and even more preferably 0.20 or more, from the viewpoints that crystals are less likely to be oriented in the plane direction when the density is increased, and deterioration of charge-discharge load characteristics can be avoided. The Raman R value is preferably 0.80 or less, more preferably 0.70 or less, and even more preferably 0.60 or less from the viewpoints that an excessive reaction with an electrolytic solution can be suppressed, and a decrease in charge-discharge efficiency and an increase in gas generation can be avoided.

### Method for Producing Carbon Material (B)

The method for producing the carbon material (B) is not particularly limited as long as the carbon material (B) can be produced to satisfy Formula (4) described above. However, it is preferable to use scaly spheroidized natural graphite as the carbon material (B), from the viewpoints that the resultant electrode plate has good fillability, and excellent capacity is achieved.

The raw material of the carbon material (B) is preferably graphite, more preferably natural graphite or artificial graphite because of high crystallinity and excellent capacity, and even more preferably natural graphite because of higher crystallinity, more excellent capacity, and no need for heat treatment during production. The graphite preferably contains a small amount of impurities, and the graphite is more preferably subjected to a purification treatment as necessary.

Examples of the natural graphite include amorphous graphite, scale-like graphite, and scaly graphite. Among these natural graphites, scale-like graphite or scaly graphite is preferred, and scaly graphite is more preferred, because of a high degree of graphitization and a small amount of impurities.

Examples of the artificial graphite include those obtained by graphitizing an organic substance such as coal tar pitch, coal-based heavy oil, reduced crude, petroleum-based heavy oil, aromatic hydrocarbon, nitrogen-containing cyclic compound, sulfur-containing cyclic compound, polyphenylene, polyvinyl chloride, polyvinyl alcohol, polyacrylonitrile, polyvinyl butyral, natural polymer, polyphenylene sulfide, polyphenylene oxide, furfuryl alcohol resin, phenol-formaldehyde resin, or imide resin by heating at 2500° C. or higher.

The method of spheroidization treatment is preferably a method in which a mechanical energy is applied for the spheroidization treatment, from the viewpoint of controlling the shape of particles easily.

Examples of the mechanical energy include impact, compression, friction, and shear force. One type of these mechanical energies may be used alone or two or more thereof may be used in combination.

In the method of spheroidization treatment by application of a mechanical energy, an apparatus for applying a mechanical energy only need be used.

In the spheroidization treatment, the raw material may be granulated in the presence of an additional substance. Examples of the additional substance include metals that can be alloyed with lithium, oxides thereof, and raw coke.

### Composition of Carbon Material

In 100 mass % of the carbon material composition, the content of the carbon material (A) is preferably 50 mass % or more, more preferably 55 mass % or more, and even more preferably 60 mass % or more, from the viewpoints of ensuring a diffusion path of lithium ions between particles when an electrode plate is pressed, and achieving excellent charge-discharge characteristics at a high current density. The content of the carbon material (A) is preferably 95 mass % or less, more preferably 90 mass % or less, and even more preferably 85 mass % or less, from the viewpoint of achieving excellent rollability when an electrode plate is pressed.

In 100 mass % of the carbon material composition, the content of the carbon material (B) is preferably 5 mass % or more, more preferably 10 mass % or more, and even more preferably 15 mass % or more, from the viewpoints of: suppressing a side reaction with an electrolytic solution due to an increase in electrode plate specific surface area; and achieving excellent high-temperature storage characteristics. The content of the carbon material (B) is preferably 50 mass % or less, more preferably 45 mass % or less, and even more preferably 40 mass % or less, from the viewpoints of ensuring a suitable void structure between particles, and achieving excellent rapid charge-discharge characteristics.

For example, in the carbon material of the present invention, the content of the carbon material (A) may be 50 mass % to 95 mass %, and the content of the carbon material (B) may be 5 mass % to 50 mass %.

The carbon material of the present invention may contain an additional substance besides the carbon material (A) and the carbon material (B). Examples of the additional substance include metals that can be alloyed with lithium, oxides thereof, and an electrically conductive material.

The content of the additional substance is preferably 20 mass % or less, and more preferably 10 mass % or less, from the viewpoint that the original function of the carbon material is not impaired.

### Method for Producing Carbon Material

The method for producing the carbon material of the present invention includes a step of mixing the above-described carbon material (A) and the above-described carbon material (B).

The mixing method is not particularly limited as long as the carbon material (A) and the carbon material (B) can be mixed to achieve a desired composition.

The ratio Rd50 of the volume-based average particle size d50 of the carbon material (B) to the volume-based average particle size d50 of the carbon material (A) ([volume-based average particle size d50 of carbon material (B)]/[volume-based average particle size d50 of carbon material (A)]) is preferably 0.3 to 1.6, more preferably 0.4 to 1.5, and even more preferably 0.5 to 1.4.

When the ratio Rd50 is within the above range, a diffusion path of lithium ions is uniformly secured in the electrode plate, and excellent charge-discharge characteristics at a high current density are achieved.

The ratio RSAp of the specific surface area SAp of the carbon material (B) to the specific surface area SAp of the carbon material (A) ([specific surface area SAp of carbon material (B)]/[specific surface area SAp of carbon material (A)]) is preferably 2 to 15, more preferably 3 to 14, and even more preferably 4 to 13.

When the ratio RSAp is within the above range, an excessive side reaction with an electrolytic solution is suppressed, and excellent initial charge-discharge efficiency is achieved.

The ratio RTap of the tap density of the carbon material (B) to the tap density of the carbon material (A) ([tap density of carbon material (B)]/[tap density of carbon material (A)]) is preferably 0.7 to 1.4, more preferably 0.75 to 1.3, and even more preferably 0.8 to 1.2.

When the ratio RTap is within the above range, excellent slurry stability is achieved at the time of preparing an electrode plate.

### Negative Electrode

The negative electrode of the present invention includes a current collector and an active material layer formed on the current collector, and the active material layer contains the carbon material of the present invention. The carbon material of the present invention has an effect as the active material of the negative electrode.

The method for producing the negative electrode is not particularly limited as long as the active material layer can be formed on the current collector. However, the production method is preferably a method in which a slurry containing the carbon material of the present invention and a binder resin is applied onto the current collector and dried, from the viewpoint that such a method is inexpensive and provides excellent productivity. The slurry may further contain a thickener.

Preferably, a slurry containing the carbon material of the present invention and a binder resin is applied onto the current collector and dried, and then the resultant product is pressed to increase the density of the active material layer formed on the current collector, to thereby increase a battery capacity per unit volume of the active material layer.

The density of the active material layer is preferably 1.2 g/cm³ or more and more preferably 1.5 g/cm³ or more from the viewpoint that a reduction in battery capacity due to an increase in the thickness of the electrode plate can be suppressed. The density is preferably 2.0 g/cm³ or less and more preferably 1.8 g/cm³ or less, from the viewpoints that: the amount of an electrolytic solution held in voids is reduced due to a decrease in voids in the electrode plate, the migration of alkali ions such as lithium ions decreases, and deterioration of rapid charge-discharge characteristics can be suppressed.

### Secondary Battery

The secondary battery of the present invention includes a positive electrode, the negative electrode of the present invention, and an electrolyte.

The positive electrode and the negative electrode of the present invention are preferably capable of storing and releasing lithium ions.

### Positive Electrode

The positive electrode used may be any known positive electrode.

### Electrolyte

The electrolyte used may be any known electrolyte.

### Separator

In the secondary battery of the present invention, a separator is preferably interposed between the positive electrode and the negative electrode.

The separator used may be any known separator.

### Application

The carbon material of the present invention can be suitably used as an active material of a negative electrode of a secondary battery, can be more suitably used as an active material of a negative electrode of a non-aqueous secondary battery, and can be particularly suitably used as an active material of a negative electrode of a lithium ion secondary battery, from the viewpoint of achieving both the discharge load characteristic of the secondary battery and the high-temperature storage recovery rate of the secondary battery in a balanced manner.

### EXAMPLES

Hereinafter, the present invention will be described in more detail by way of Examples, but the present invention is not limited to the description of the following Examples without departing from the gist of the present invention.

### Method for Measuring Volume-Based Average Particle Size d50

0.01 g of a sample was suspended in 10 mL of a 0.2 mass % aqueous solution of polyoxyethylene sorbitan monolaurate (trade name “Tween 20”, available from Fujifilm Wako Pure Chemical Industries, Ltd.) as a surfactant, the suspension was introduced into a laser diffraction/scattering particle size distribution analyzer (model name “LA-920”, available from HORIBA, Ltd.) and irradiated with ultrasonic waves of 28 kHz at an output power of 60 W for 1 minute, then a volume-based median size in the analyzer was measured, and the measured volume-based median size was taken as the volume-based average particle size d50.

### Method for Measuring Tap Density

A powder density measuring device (model name “Tap Denser KYT-3000”, available from Seishin Enterprise Co., Ltd.) was used. A sample was dropped into a cylindrical tap cell having a diameter of 1.6 cm and a volumetric capacity of 20 cm³ to fill the cell to a full capacity, tapping was then performed 1000 times with a stroke length of 10 mm, and a density calculated from the volume and the mass of the sample at that time was taken as the tap density.

### Method for Measuring Powder Specific Surface Area SAp

A specific surface area measuring apparatus (model name “Macsorb HM Model-1210”, available from MOUNTECH Co., Ltd.) was used. A sample was preliminarily dried under reduced pressure at 350° C. for 15 minutes under a nitrogen gas flow and then cooled to a liquid nitrogen temperature, a nitrogen-helium mixed gas accurately adjusted in such a manner that the value of a relative pressure of nitrogen to the atmospheric pressure was 0.3 was used to measure the specific surface area by a nitrogen adsorption single-point BET method based on a gas flow method, and the measured specific surface area was taken as the powder specific surface area SAp.

### Preparation of Negative Electrode Sheet

50.00±0.02 g of the carbon material produced in each of Examples and Comparative Examples was mixed with 50.00±0.02 g of a 1 mass % aqueous sodium carboxymethyl cellulose solution (0.50 g on a solid basis) and 1.00±0.05 g of an aqueous dispersion of styrene-butadiene rubber dispersion having a weight average molecular weight of 270000 (0.50 g on a solid basis) with stirring for 5 minutes using a hybrid mixer (available from KEYENCE CORPORATION) and defoamed for 30 seconds to prepare a slurry.

The prepared slurry was dried in such a manner that 10.0±0.2 mg/cm² of the negative electrode material was attached on a 10 μm-thick copper foil as a current collector. Further, roll pressing was performed to adjust the density of the negative electrode active material layer to 1.3±0.03 g/cm³ to 1.7±0.03 g/cm^{3,} thereby preparing a negative electrode sheet (electrode plate).

### Preparation of Positive Electrode Sheet

85 mass % of lithium nickel manganese cobalt oxide (LiNiMnCoO₂) as a positive electrode active material was mixed with 10 mass % of acetylene black as an electrically conductive material and 5 mass % of polyvinylidene fluoride (PVdF) as a binder in N-methylpyrrolidone to prepare a slurry.

The prepared slurry was applied onto a 15 μm-thick aluminum foil as a current collector in such a manner that the positive electrode material was attached at 22.5±0.2 mg/cm², and then dried. In addition, roll pressing was performed to adjust the density of the positive electrode active material layer to 2.6±0.05 g/cm³, thereby preparing a positive electrode sheet.

### Preparation of Sheet-Shaped Secondary Battery

The prepared negative electrode sheet, a separator made of polyethylene, and the prepared positive electrode sheet were laminated in this order. The resultant laminate was wrapped by a cylindrical aluminum laminate film, and an electrolytic solution in which LiPF₆ was dissolved in a mixed solvent of ethylene carbonate and dimethyl carbonate (volume ratio 30:70) to achieve 1 mol/L was injected into the wrapped laminate, followed by vacuum sealing to prepare a sheet-shaped non-aqueous secondary battery. To increase adhesiveness, the sheet-shaped secondary battery was sandwiched between glass plates and pressurized.

### Method for Measuring Electrode Plate Specific Surface Area SAe

A specific surface area measuring apparatus (model name “Macsorb HM Model-1210”, available from MOUNTECH Co., Ltd.) was used. A sample was preliminarily dried under reduced pressure at 100° C. for 30 minutes under a nitrogen gas flow and then cooled to the liquid nitrogen temperature, a nitrogen-helium mixed gas accurately adjusted in such a manner that the value of the relative pressure of nitrogen to the atmospheric pressure was 0.3 was used to measure a specific surface area by the nitrogen adsorption single-point BET method based on the gas flow method, and the measured specific surface area was taken as the electrode plate specific surface area SAe.

### Method for Measuring Press Inflection Point Density

In a curve of press load-negative electrode active material layer density obtained when the negative electrode sheet was pressed, an intersection of a tangent line in a low density region drawn from a load 0 point and a tangent line drawn in a region where the density linearly changes in a high density region was obtained, and the negative electrode active material layer density corresponding to the load of the obtained intersection was taken as the press inflection point density.

The displacement, deformation, or cracking of carbon material particles forming the negative electrode sheet occurs with pressing of the negative electrode sheet, and the density of the negative electrode active material layer increases. The press inflection point density is an index indicating a change in each phenomenon occurring in the carbon material particles.

### Method for Measuring Rate of Change in Tortuosity Factor

Two disks each having a diameter of 12.5 mm were prepared by punching out each of the negative electrode sheets prepared at different press densities, and the disks were arranged in such a manner that the active material layers face each other. A separator (made of a porous polyethylene film) impregnated with an electrolytic solution prepared by dissolving LiPF₆ in a mixed solvent of ethylene carbonate and ethyl methyl carbonate (volume ratio 30:70) to achieve 1 mol/L was placed between the facing negative electrode sheets to prepare a 2016 coin battery.

The prepare 2016 coin battery was allowed to stand at 25° C. for 24 hours, and then impedance response analysis was performed. In the impedance response analysis, measurement was performed using an impedance analyzer (available from Solartron Metrology) under conditions of a frequency of 20 kHz to 10 mHz and a voltage amplitude of 10 mV. An intersection of a 45° straight line in a high frequency region and a vertical line in a low frequency region on a Cole-Cole plot was used to determine an ionic resistance Rᵢₒₙ for the active material layer of the negative electrode sheet. The tortuosity factor was calculated from the following Formula (5), wherein S represents the area of the negative electrode sheet, L represents the thickness of the active material layer of the negative electrode sheet, σ represents the electrical conductivity of the electrolytic solution, and ϵ represents the porosity of the active material layer.

$$Tortuosity factor = {R}_{ion} \times ( ε / 2 \times L ) \times ( σ \times S ) \qquad ( 5 )$$

The calculated tortuosity factor was used to calculate the rate of change in tortuosity factor in a press density range of 1.3 g/cm³ to 1.7 g/cm³ from the following Formula (6).

$$[ Rate of change in tortuosity factor ] = [ amount of change in tortuosity factor ] / [ amount of change in press density ] \qquad ( 6 )$$

### Method for Measuring Discharge Load Characteristic

The prepared sheet-shaped secondary battery was subjected to initial charging-discharging at 25° C. for 3 cycles in a voltage range of 4.1 V to 3.0 V and a current value of 0.2 C (1C is defined by a current value at which a rating capacity based on a discharge capacity in one hour rate is discharged in one hour, the same shall apply hereinafter) and for 2 cycles in a voltage range of 4.2 V to 3.0 V and a current value of 0.2 C (constant-voltage charging at 4.2 V was further performed for 2.5 hours during charging). Thereafter, constant-current charging was performed at a current value of 0.2 C up to 4.2 V, constant-voltage charging was further performed at 4.2 V for 2.5 hours, constant-current discharging was performed at 3 C up to 3.0 V, and the ratio of the discharge capacity during 3 C discharging to the discharge capacity during 0.2 C discharging represented by the following Formula (7) was taken as the discharge load characteristic (%).

$$Discharge load characteristic ( \% ) = ( [ discharge capacity during 3 C discharging ] / [ discharge capacity during 0.2 C discharging ] ) \times 100 \qquad ( 7 )$$

### Method for Measuring High-Temperature Storage Recovery Rate

The prepared sheet-shaped secondary battery was subjected to initial charging/discharging at 25°° C. for 3 cycles in a voltage range of 4.1 V to 3.0 V and a current value of 0.2 C and for 2 cycles in a voltage range of 4.2 V to 3.0 V and a current value of 0.2 C (constant-voltage charging was further performed at 4.2 V for 2.5 hours during charging). The secondary battery was further charged at a current value of 0.2 C to a charging rate (SOC) of 80%, and then stored at 60° C. for 2 weeks. Thereafter, the secondary battery was discharged at a current value of 0.2 C, and further charged and discharged at a current value of 0.2 C (constant-voltage charging was further performed at 4.2 V for 2.5 hours during charging), and the ratio of the discharge capacity after storage to the discharge capacity after initial charging and discharging represented by the following Formula (8) was taken as the high-temperature storage recovery rate (%).

$$High - temperature storage recovery rate ( \% ) = ( [ discharge capacity after storage ] / [ discharge capacity after initial charging and discharging ] ) \times 100 \qquad ( 8 )$$

### [Production Example 1] Production of Carbon Material (A1)

Scaly natural graphite having a volume-based average particle size of 100 μm was pulverized to prepare graphite having a volume-based average particle size of 11 μm. After 100 parts by mass of the prepared graphite was mixed with 12 parts by mass of a granulating agent, spheroidization treatment was performed, and the granulating agent was removed by heat treatment to prepare spheroidized graphite (volume-based average particle size: 16 μm, specific surface area: 15 m²/g, tap density: 0.96 g/cm³). The prepared spheroidized graphite was charged in a rubber container, and the rubber container was sealed and isotropic pressurization treatment was performed, followed by disintegration and classification treatment to prepare a spheroidized graphite powder. The prepared spheroidized graphite powder was mixed with pitch (ash content: 0.02 mass %, metallic impurity content: 20 mass ppm, Qi: 1 mass %) as an amorphous carbonaceous substance precursor, and the mixture was subjected to a heat treatment at 1300° C. in an inert gas atmosphere in which the pressure in a furnace was reduced to 10 torr or less and returned to atmospheric pressure with nitrogen gas, and nitrogen was further flown to make the oxygen concentration in the furnace 0.01 vol % or less. The resultant fired product was disintegrated and classified to produce a carbon material (A1). The mass ratio of the spheroidized graphite to the amorphous carbonaceous substance in the produced carbon material (A1) was 1:0.08.

The evaluation results of the produced carbon material (A1) are shown in Table 1.

### [Production Example 2] Production of Carbon Material (A2)

A carbon material (A2) was produced in the same manner as in Production Example 1 except that the mixing ratio of the spheroidized graphite powder to the amorphous carbonaceous substance precursor was changed. The mass ratio of the spheroidized graphite to the amorphous carbonaceous substance in the produced carbon material (A2) was 1:0.095.

The evaluation results of the produced carbon material (A2) are shown in Table 1.

### [Production Example 3] Production of Carbon Material (A3)

A carbon material (A3) was obtained in the same manner as in Production Example 1 except that the mixing ratio of the spheroidized graphite powder to the amorphous carbonaceous substance precursor was changed. The mass ratio of the spheroidized graphite to the amorphous carbonaceous substance in the produced carbon material (A3) was 1:0.11.

The evaluation results of the obtained carbon material (A3) are shown in Table 1.

### [Production Example 4] Production of Carbon Material (B1)

Scaly natural graphite having a volume-based average particle size of 100 μm was subjected to spheroidization treatment to produce a carbon material (B1).

The evaluation results of the produced carbon material (B1) are shown in Table 2.

### [Production Example 5] Production of Carbon Material (B2)

Scaly natural graphite having a volume-based average particle size of 100 μm was subjected to spheroidization treatment to produce a carbon material (B2).

The evaluation results of the produced carbon material (B2) are shown in Table 2.

### [Production Example 6] Production of Carbon Material (B3)

Scaly natural graphite having a volume-based average particle size of 100 μm was subjected to spheroidization treatment to produce a carbon material (B3).

The evaluation results of the produced carbon material (B3) are shown in Table 2.

### Example 1

80 mass % of the carbon material (A1) and 20 mass % of the carbon material (B2) were mixed to produce a carbon material.

The evaluation results of the produced carbon material are shown in Table 4.

### Examples 2 to 4

Carbon materials were produced in the same manner as in Example 1, except that the types and contents of the carbon materials were changed as shown in Table 3.

The evaluation results of the produced carbon materials are shown in Table 4.

### Comparative Examples 1 to 6

Carbon materials were produced in the same manner as in Example 1, except that the types and contents of the carbon materials were changed as shown in Table 3.

The evaluation results of the produced carbon materials are shown in Table 4.

TABLE 1

| | Volume-based | Tap | Powder specific | Rate of change |
|---|---|---|---|---|
| | average particle | density | surface area SAp | in tortuosity |
| | size d50 [μm] | [g/cc] | [m²/g] | factor α1 |
| Production | 16.2 | 1.17 | 1.7 | 4.6 |
| Example 1 | | | | |
| Production | 16.6 | 1.20 | 1.2 | 4.4 |
| Example 2 | | | | |
| Production | 16.5 | 1.17 | 0.9 | 3.1 |
| Example 3 | | | | |

TABLE 2

| | Volume-based | Tap | Powder specific | Rate of change |
|---|---|---|---|---|
| | average particle | density | surface area SAp | in tortuosity |
| | size d50 [μm] | [g/cc] | [m²/g] | factor α2 |
| Production | 7.8 | 0.92 | 12.1 | 10.6 |
| Example 4 | | | | |
| Production | 17.2 | 1.00 | 6.2 | 10.8 |
| Example 5 | | | | |
| Production | 16.8 | 1.06 | 6.4 | 16.3 |
| Example 6 | | | | |

TABLE 3

| | Carbon material (A) | | Carbon material (B) | |
|---|---|---|---|---|
| | Type | Content [mass %] | Type | Content [mass %] |
| Example 1 | (A1) | 80 | (B2) | 20 |
| Example 2 | (A1) | 70 | (B2) | 30 |
| Example 3 | (A2) | 80 | (B3) | 20 |
| Example 4 | (A3) | 70 | (B3) | 30 |
| Comparative | (A1) | 100 | — | — |
| Example 1 | | | | |
| Comparative | (A2) | 100 | — | — |
| Example 2 | | | | |
| Comparative | (A3) | 100 | — | — |
| Example 3 | | | | |
| Comparative | — | — | (B1) | 100 |
| Example 4 | | | | |
| Comparative | — | — | (B2) | 100 |
| Example 5 | | | | |
| Comparative | — | — | (B3) | 100 |
| Example 6 | | | | |

TABLE 4

| | Electrode | Powder | | | Press | | High- |
|---|---|---|---|---|---|---|---|
| | plate | specific | | Rate of | inflection | Discharge | temperature |
| | specific | surface | | change in | point | load | storage |
| | surface area | area SAp | Formula (1) | tortuosity | density | characteristic | recovery |
| | SAe [m²/g] | [m²/g] | SAe/SAp | factor α | [g/mL] | [%] | rate [%] |
| Example 1 | 2.3 | 2.6 | 0.86 | 6 | 1.50 | 74 | 96 |
| Example 2 | 2.5 | 3.1 | 0.80 | 8 | 1.60 | 75 | 95 |
| Example 3 | 2.0 | 2.3 | 0.86 | 4 | 1.50 | 75 | 96 |
| Example 4 | 2.0 | 2.6 | 0.80 | 10 | 1.50 | 75 | 97 |
| Comparative | 2.7 | 1.7 | 1.57 | 5 | 1.60 | 74 | 93 |
| Example 1 | | | | | | | |
| Comparative | 1.8 | 1.2 | 1.42 | 4 | 1.45 | 74 | 94 |
| Example 2 | | | | | | | |
| Comparative | 1.6 | 0.9 | 1.78 | 3 | 1.50 | 77 | 94 |
| Example 3 | | | | | | | |
| Comparative | 6.3 | 12.1 | 0.52 | 11 | 1.80 | 66 | 90 |
| Example 4 | | | | | | | |
| Comparative | 3.4 | 6.2 | 0.54 | 11 | 1.80 | 71 | 94 |
| Example 5 | | | | | | | |
| Comparative | 3.6 | 6.4 | 0.56 | 16 | 1.80 | 73 | 92 |
| Example 6 | | | | | | | |

As can be seen from Table 4, the carbon materials of Examples 1 to 4, which were the carbon materials of the present invention, resulted in excellent discharge load characteristic and high-temperature storage recovery rate of the secondary battery. In contrast, the carbon materials of Comparative Examples 1 to 3, which did not satisfy the requirements of the present invention, resulted in inferior high-temperature storage recovery rate of the secondary battery. Similarly, the carbon materials of Comparative Examples 4 to 6, which did not satisfy the requirements of the present invention, resulted in inferior discharge load characteristic and high-temperature storage recovery rate of the secondary battery. It is considered that these results were obtained because the carbon material satisfied both Formula (1) and Formula (2), or contained the carbon material (A) satisfying Formula (3) and the carbon material (B) satisfying Formula (4), thereby suppressing an increase in electrode plate specific surface area when the electrode plate was pressed to a high density, and satisfactorily maintaining the void structure in the electrode plate necessary for diffusion of lithium ions.

Although various embodiments have been described above, it is needless to say that the present invention is not limited to such embodiments. It will be apparent to those skilled in the art that various changes and modifications can be made within the scope of the claims, and it should be understood that such changes and modifications naturally fall within the technical scope of the present invention. In addition, the constituent elements in the above-described embodiments may be arbitrarily combined without departing from the gist of the invention.

The present application is based on JP 2022-124174 filed on Aug. 3, 2022, the content of which is incorporated herein by reference.

### INDUSTRIAL APPLICABILITY

The carbon material of the present invention can be suitably used as an active material of a negative electrode of a secondary battery, can be more suitably used as an active material of a negative electrode of a non-aqueous secondary battery, and can be particularly suitably used as an active material of a negative electrode of a lithium ion secondary battery, from the viewpoint of achieving both the discharge load characteristic of the secondary battery and the high-temperature storage recovery rate of the secondary battery in a balanced manner.

1. A carbon material, satisfying formulas (1) and (2):
$$0.1 \leq SAe / SAp \leq 1.2 \underline{; and} \qquad ( 1 )$$
$$1 \leq α \leq 10 \underline{,} \qquad ( 2 )$$
wherein, in formula (1),
SAp is a specific surface area of the carbon material in powder form, and
SAe is a specific surface area at an inflection point in a load-density curve when the carbon material is pressed into an electrode plate and
wherein, in formula (2),
α is a rate of change in tortuosity factor in a press density range of from 1.3 g/cm³ to 1.7 g/cm³ of the carbon material.

2. The carbon material of claim 1, wherein SAp is in a range of from 1.5 m²/g to 4.5 m²/g.

3. The carbon material of claim 1, wherein SAe is in a range of from 0.5 m²/g to 3.5 m²/g.

4. The carbon material of claim 1, having a volume-based average particle size in a range of from 5 μm to 25 μm.

5. A carbon material, comprising:
a first carbon material (A) satisfying formula (3); and
a second carbon material (B) satisfying formula (4):
$$0.1 \leq α1 \leq 6 \underline{; and} \qquad ( 3 )$$
$$8 \leq α2 \leq 20 \underline{,} \qquad ( 4 )$$
wherein, in formula (3),
α1 is a rate of change in tortuosity factor in a press density range of from 1.3 g/cm³ to 1.7 g/cm³ of the carbon material and
wherein, in formula (4),
α2 is a rate of change in tortuosity factor in a press density range of from 1.3 g/cm³ to 1.7 g/cm³ of the carbon material.

6. The carbon material of claim 5, wherein a ratio Rd50 of a volume-based average particle size of the carbon material (B) to a volume-based average particle size of the carbon material (A) is in a range of from 0.3 to 1.6.

7. The carbon material of claim 5, wherein an RSAp ratio, of a specific surface area of the carbon material (B) to a specific surface area of the carbon material (A), is in a range of from 2 to 15.

8. The carbon material of claim 5, wherein an RTap ratio, of a tap density of the carbon material (B) to a tap density of the carbon material (A), is in a range of from 0.7 to 1.4.

9. The carbon material of claim 5, wherein the carbon material comprises the first carbon material (A) in a range of from 50 mass % to 95 mass % and the second carbon material (B) in a range of from 5 mass % to 50 mass %.

10. A method for producing the carbon material of claim 5, the method comprising:
mixing the carbon material (A) and the carbon material (B).

11. A negative electrode, comprising:
a current collector; and
an active material layer formed on the current collector,
wherein the active material layer comprises the carbon material of claim 1.

12. A secondary battery, comprising:
a positive electrode;
the negative electrode of claim 11; and
an electrolyte.
